(19) United States
(12) Patent Application Publication
(10) Pub. No.: US 2013/0211921 A1
(43) Pub. Date: Aug. 15, 2013

(54) SYSTEM AND METHOD FOR PROVIDING AFFILIATE MARKETING SERVICE IN INTEGRATED MARKETPLACE

(71) Applicant: NHN Business Platform corporation, (US)

(72) Inventors: Jin-Woo CHOI, Seongnam-si (KR); Yunkyung CHO, Seongnam-si (KR)

(73) Assignee: NHN BUSINESS PLATFORM CORPORATION, Seongnam-si (KR)

(21) Appl. No.: 13/686,106

(22) Filed: Nov. 27, 2012

(30) Foreign Application Priority Data
Feb. 10, 2012 (KR) 10-2012-0013934

(51) Int. Cl. G06Q 30/02; G06Q 50/00

(52) U.S. Cl. CPC G06Q 30/0273; G06Q 50/01
USPC 705/14.69

(57) ABSTRACT

A system and method for providing an advertisement that provides an affiliate marketing service in an integrated e-marketplace is disclosed. The system for providing the advertisement included in a portal site managing system which managing system provides a plurality of services including at least one of a shopping information providing service, a social networking service, a web document searching service, a personal page managing service, and a payment service.

### CROSS REFERENCE TO RELATED APPLICATION

This application claims priority from and the benefit of Korean Patent Application No. 10-2012-0013934, filed on Feb. 10, 2012, which is hereby incorporated by reference for all purposes as if fully set forth herein.

### BACKGROUND OF THE INVENTION

1. Field of the Invention

Exemplary embodiments of the present invention relate to a system and method for providing an advertisement that provides an affiliate marketing service in an integrated e-marketplace.

2. Discussion of the Background

E-commerce or E-business may refer to a business between a company and a consumer on the Internet. An E-marketplace is a mediator that connects a supplier and the consumer through the Internet. A key to the E-marketplace is connecting the supplier and the is consumer without needing a third-party between the supplier and the consumer. E-business profits may be obtained from a commission earned by making a sale, a deal, for example, through registration fees.

FIG. 1 is a diagram illustrating a platform structure of an E-marketplace according to a conventional art. A conventional E-marketplace may include a registering platform 110 to register product information, a publishing platform 120 to publish information about the registered product, and an affiliate platform 130 for affiliate marketing. Affiliate marketing is employed to increase traffic and sales by gathering information on an affiliate 140 that is an E-commerce merchant site advertising a website of a consumer. For example, when a performance result (e.g., visit) is obtained through the affiliate site in a pay-for-performance scheme, an advertising fee may be paid to the affiliate 140.

The registering platform 110 may be operated through a system of an online auction, or an online shopping mall company such as eBay®. The publishing platform 120 may be operated through a system that provides a personal webpage service, a system of a portal site that provides a café, a blog, a homepage, or a system of a reward website. The affiliate platform 130 may operate through a system of a company providing the affiliate marketing. Accordingly, each platform may be operated as a separate system in the conventional art.

### SUMMARY OF THE INVENTION

Exemplary embodiments of the present invention provide an integrated system and method for providing an advertisement that provides an integrated E-marketplace by processing a registration, a display, a sale, and a payment of a product.

Exemplary embodiments of the present invention also provide an integrated system and method for providing an advertisement that processes a registration, a display, a sale, and a payment of a product, by utilizing services provided by a portal site operating system operating a portal site.

Exemplary embodiments of the present invention also provide a system and method for providing an advertisement that enhances an advertising effect by providing a predetermined reward to a user working as an affiliate through an affiliate platform for an affiliate marketing, as well as providing an integrated e-marketplace by processing a registration, a display, a sale, and a payment integrally.

Additional features of the invention will be set forth in the description which follows, and in part will be apparent from the description, or may be learned by practice of the invention.

A system for providing an advertisement on a portal site operating system, the system including a processor, a product information receiver to receive information, about a product provided to a personal page through a personal page managing service, a product register to register the product based on the information, and a reward provider unit to provide a reward for uploading the information in response to the information uploaded through a social networking service and the product being purchased via the uploaded information.

Exemplary embodiments of the present invention also provide a method of providing an advertisement in a portal site operating system, the method including receiving information about a product provided to a personal page through a personal page managing service, registering, in a storage unit, the product based on the information, and providing a reward for uploading the information in response to the information being uploaded through a social networking service and the product being purchased via the uploaded information.

Exemplary embodiments of the present invention also provide a non-transitory computer-readable recording medium storing a program, that when executed by a processor, implements a method, including receiving information about a product provided to a personal page through a personal page managing service, registering, in a storage unit, the product based on the information, and providing a reward for uploading the information in response to the information being uploaded through a social networking service and the product being purchased via the uploaded information.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a diagram illustrating a platform structure of an E-marketplace according to conventional art.

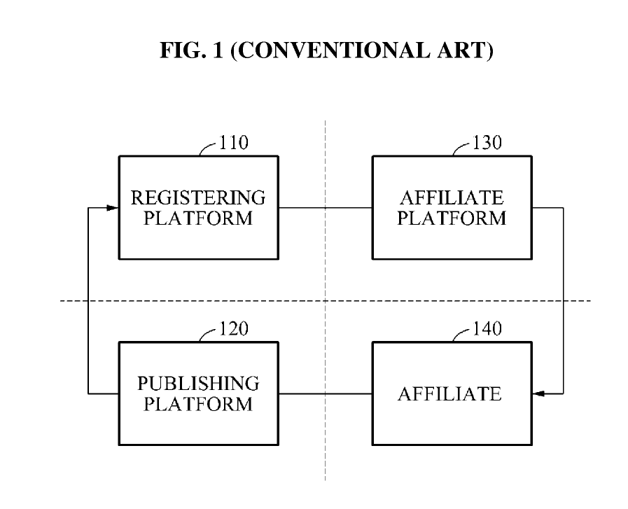

FIG. 2 is a diagram illustrating an overview of a portal site operating system and a system for providing an advertisement according to exemplary embodiments of the present is invention.

FIG. 3 is a diagram illustrating an overview of a method for providing an advertisement according to exemplary embodiments of the present invention.

FIG. 4 is an example illustrating a process of exchanging information of a product through a social networking service according to exemplary embodiments of the present invention.

FIG. 5 is a diagram illustrating a platform structure according to exemplary embodiments of the present invention.

FIG. 6 is a block diagram illustrating an internal configuration of a system for providing an advertisement according to exemplary embodiments of the present invention.

FIG. 7 is a flowchart illustrating a method for providing an advertisement according to exemplary embodiments of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element is referred to as being “on” or “connected to” another element, it can be directly on or directly connected to the other element, or intervening elements may be present. In contrast, when an element is referred to as being “directly on” or “directly connected to” another element, there are not intervening elements present. It may also be understood that for the purposes of this disclosure, “at least one of X, Y, and Z” can be construed to as X only, Y only, Z only, or any combination of two or more items X, Y, and Z (e.g., XYX, XYY, YZ, ZZ).

The terminology used herein is for the purpose of describing exemplary embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising”, when used in this specification, specify the presence of stated features, integers, steps, operations, elements and/or components, but do not preclude the presence or addition of one or more other features, integers, steps, operations, elements, components, and/or groups thereof.

Hereinafter, exemplary embodiments of the present invention are described in detail with reference to the accompanying drawings.

Exemplary embodiments of the present invention are directed to a system and method for providing an advertisement. The system for providing the advertisement may include a portal site operating system that provides various services to users, for example, a portal site.

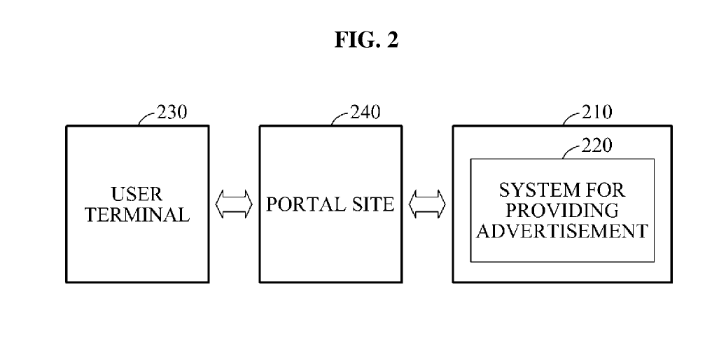

FIG. 2 is a diagram illustrating an overview of a portal site operating system 210 and a system for providing an advertisement 220. The system for providing the advertisement 220 may, in some cases, be included in the portal site operating system 210 (as shown in FIG. 2), or may, in some cases, be separate but connected to the portal site operating system 210. The portal site operating system 210 may provide a portal site 240 to a user requesting access through a user terminal 230, and provide services through the portal site 240.

The services provided to users through the portal site 240 may be, for example, at least one of a shopping information providing service, a web document searching service, a personal page managing service, a social networking service, and a payment service. The shopping information providing service may include a product searching service. The web document searching service may include a service that provides specific webpages through a keyword or image search. The personal page managing service may include a service that assigns and manages a page associated with a specific uniform resource locator (URL) to a user subscribing as a member to a blog, a café, and/or a homepage. A webpage for an advertisement search may be included in a webpage provided by the web document searching service. The social networking services may include a service that enables users on a web to form a human network. The social networking services may be combined with a personal web environment (PWE) and/or a personal page managing service.

The system for providing the advertisement 220 included in the portal site operating system 210 may provide at least one of the shopping information providing service, the web document searching service, the personal page managing service, the social networking service, and the payment service directly or indirectly. The system for providing the advertisement 220 may register a product through a personal page assigned to a user subscribed as a member, and may display information with respect to a registered personal page or a registered product using at least one of the various aforementioned services to users.

The portal site 240 and the various services provided by the portal site 240 may be, for example, utilized for the integrated E-marketplace through the system for providing the advertisement 220.

When information with respect to the registered personal page or the registered product is uploaded through the social networking service, and a purchase of a product occurs through the uploaded information, the system for providing the advertisement 220 may provide a predetermined reward to a user who uploaded the information. The system for providing the advertisement 220 may include an affiliate platform for affiliate marketing. A main publisher for the affiliate marketing may utilize the various services provided by the portal site 240.

For example, in case of service A being provided by the system for providing the advertisement 220 or the portal site operating system 210, and information with respect to a product registered on a personal page B of a user b or the personal page B on which the product is registered is uploaded by a user c through the service A, when user d purchases the product through the uploaded information by visiting the personal page B, the predetermined reward may be provided to the user c who uploaded the information.

The social networking services may be utilized in conjunction with the personal page managing service that provides and manages a personal page such as a blog, a cafë, and/or a homepage. A product may be purchased through the personal page on which the product is registered for a first time. Information uploaded through the social networking service may include a web site address or link to the personal page on which the product is registered for the first time. As an example, the user c may obtain the information about the product registered from the personal page B of the user b and provide the information on a personal page C of the user c. A link to the personal page B may be provided in the uploaded information of the product on personal page C. When the user d visits the personal page C and/or purchases the product by visiting the personal page B through the link, the system for providing the advertisement 220 may provide the predetermined reward to the user c.

The predetermined reward may be provided through various suitable manners including, for example, in a form of “points” that may be managed by the portal site operating system 210. In some cases, the predetermined reward may be provided only to users uploading information through the social networking service, or the personal page for a first time. “Points” may be defined as a unit of value used practically or virtually (e.g., cyber money, points, or mileage) corresponding to money used in the non-virtual (i.e., real) world. For example, the cyber money may have a 1:1 ratio to the money (i.e., US Dollars) used in reality. In some cases, the cyber money may also have a 1:10 ratio to money used in reality.

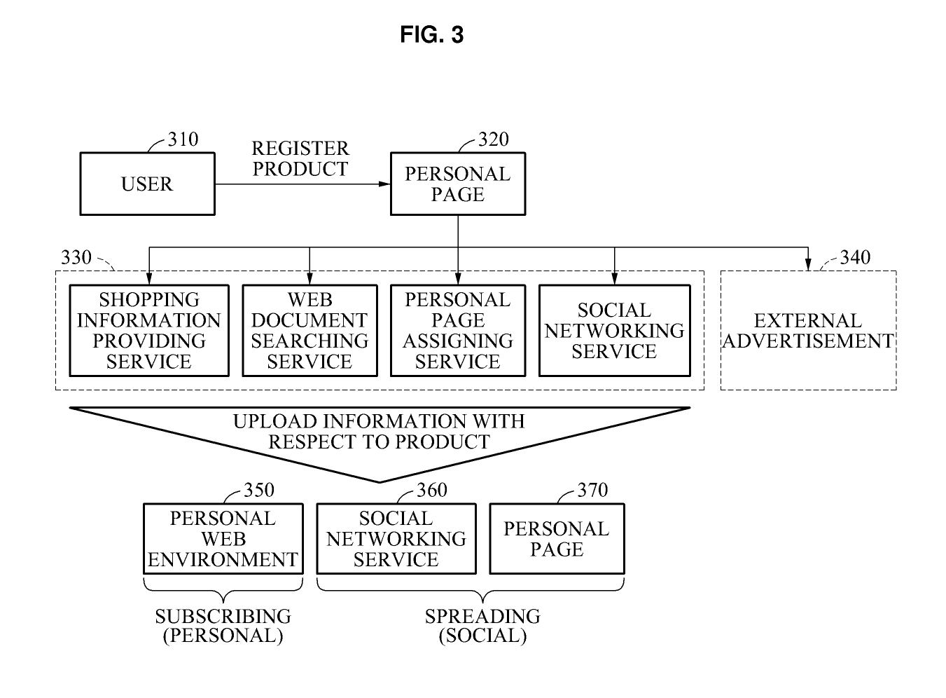

FIG. 3 is a diagram illustrating an overview of a method for providing an advertisement. A user 310 may register a product through a personal page 320 assigned to the user 310. A system for providing an advertisement may display information about a product, or a personal page 320, through various services 330. For example, the system for providing the advertisement may display the information using a shopping information providing service when a product is searched for, or may display the information by including the information in a result found using a web document searching service. The system for providing the advertisement may also display information through a cafë, a blog, and/or a homepage, using a personal page managing service, or display the information through a social networking service. Further, the system for providing the advertisement may display the information through an external advertisement 340. The “external advertisement” 340 may refer to another portal site or another publication.

As used herein, the “publication” may include a “site”. However, the “site” may not be construed as excluding executability of the present invention in an environment of an unusual website connection, for example, an application screen implemented in a mobile terminal, rather than a website connection of a personal computer (PC). Conversely, the “site” may be compatible with a “publishing site” or the “publication”. That is, each site may correspond to an individual publication. Herein, the “site” may include a type of websites through which an advertisement may be displayed and provided via a wired/wireless network to a user, and indicate a single webpage configuring a website.

“Displaying” information of an advertisement and/or a product may include providing promotional content to a visitor of a site. The displayed information may include a text, an image, a sound, a video, and/or a hyperlink, associated with an advertiser through the site or the publication. Further, “selection” of the displayed advertisement may include an occurrence where the advertiser intends to achieve delivery of promotional content, for example, by displaying a response to a mouse click. For example, the “selection” may be a web page associated with the advertiser displayed upon the user selecting an advertisement.

Other users may also subscribe to the displayed information. For example, information may be provided to users applying to subscribe through a personal web environment (PWE) 350, and the users may verify the information. The personal space may include personal web storage space, and may be provided through a webpage that supports bookkeeping service, calendar service, or schedule management service. For example, the users may verify the information provided to the personal webpage through the wired/wireless Internet connection. Information subscribed by the user may be uploaded to the personal web storage space based on conditions set by the users.

The displayed information may be uploaded, and/or spread, through the social networking service 360 or the personal page 370 by the users. For example, information displayed once by the users may be displayed to other users. In some cases, the system for providing the advertisement may provide the predetermined reward to users who upload information.

Although the social networking service 360 and the personal page 370 are illustrated separately in FIG. 3, a blog, a cafë, and/or a homepage, may be included in the social networking service 360 for forming a relationship with other users. Uploading information with respect to a product through the social networking service 360 may include delivering the information about the product through E-mail.

A payment service may include a check-out payment service. The check-out payment service may include a service that allows users to purchase and pay for a product with an identification (ID) provided by payment service through the portal site. Payment for a product, provided on a personal page, may be made using the check-out payment service. The check-out payment service may support a payment using, for example, reserved points, and/or payment vouchers.

An overall process of registering, displaying, selling, and paying of a product may be processed integrally. The affiliate marketing with respect to the product may be processed in an integrated system by using the system for providing the advertisement according to embodiments in the present invention.

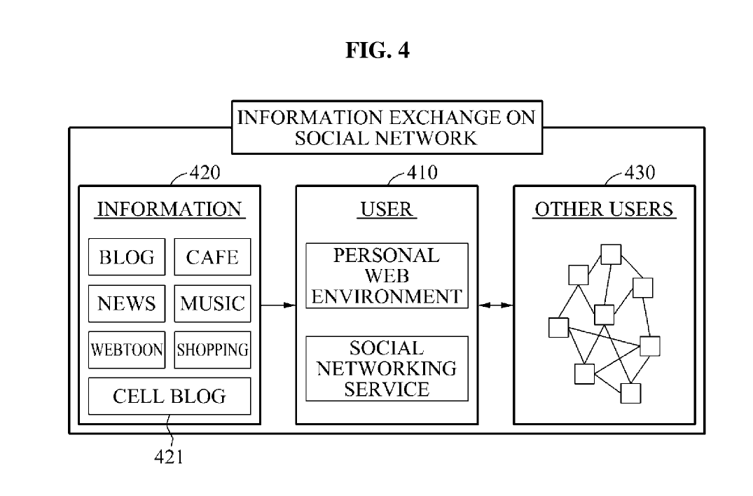

FIG. 4 is an example illustrating a process of exchanging information with respect to a product through a social networking service.

A user 410 may subscribe to information 420 about a product displayed through various services through a PWE. The user 410 may upload the information 420 through a social networking service. The information 420 may be displayed on a blog, a cafë, news, a webtoon, and/or a shopping site. A cell blog 421 may include a personal page on which the information 420 is registered. Information that the user 410 subscribes through the PWE may be uploaded through the social networking service by the user 410. The information that the user 410 subscribes through the PWE may also be uploaded through the social networking service. The information 420 uploaded through the social networking service may be displayed to users forming a relationship with the user 410. When at least one of the users purchases a product through the displayed information 420, a predetermined reward may be provided to the user 410. Purchasing of the product may be restricted to a purchase in the cell blog 421. For example, the user 410 may work as an affiliate in an integrated E-marketplace without an additional subscription.

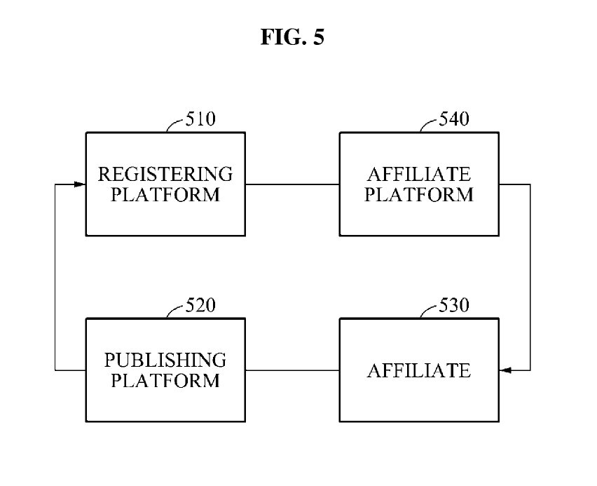

FIG. 5 is a diagram illustrating a platform structure. Exemplary embodiments of the present invention provide a single integrated system including a registering platform 510 that registers information about a product for sale, a publishing platform 520 that publishes information about the registered product, and an affiliate platform 540 that manages a performance of an affiliate 530 and distributes profits. Accordingly, a process of registering, displaying, selling, paying, and distributing of the profits of the product may be conducted through an integrated single system. For example, the integrated E-marketplace may be provided with the various services offered through a single portal site.

The registering platform 510 may manage detailed information of a product registered through a cell blog by an additional input, and manage trending interests or purchase reviews by users about the product. The registering platform 510 may also receive, and manage, input of information about an event or a promotion, and display the information about the event, or the promotion.

The publishing platform 520 may be utilized with social networking services to promote information about a product through buzz marketing, or viral marketing, and/or direct product advertisement using a blog, a cafë, homepage, and/or E-mail. The publishing platform 520 may provide traffic to the cell blog by displaying information about the product or the cell blog through blog, cafë, homepage, E-mail, and/or social networking service. For example, the publishing platform 520 may be able to provide an advertisement that promotes a product by attracting the users to the cell blog.

The affiliate 530 may be a member of the portal site operating system 210 described in FIG. 2, however, when necessary, may be restricted to members of a check-out payment service provided by the portal site operating system 210.

The affiliate platform 540 may distribute profits by managing performance of the affiliate 530. For example, a predetermined reward such as points or payment voucher may be provided to the affiliate 530 that promotes a product by uploading the information about the product through a social networking service. Members of the payment service may be encouraged to promote the information about the product to other users.

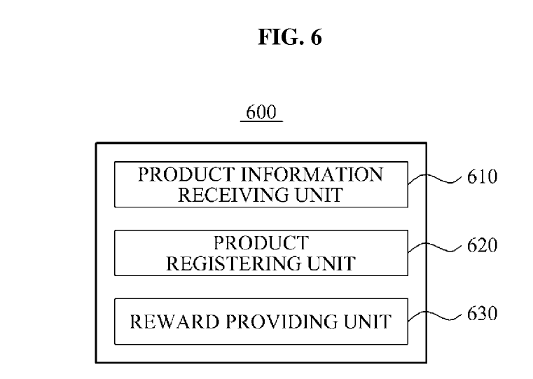

FIG. 6 is a block diagram illustrating an internal configuration of a system for providing an advertisement 600.

Referring to FIG. 6, the system for providing the advertisement 600 may include a system that may provide plurality of services including at least one of a social networking service, a web document searching service, a personal page managing service, and a payment service, using the portal site. The system for providing the advertisement 600 may include a product information receiving unit 610, a product registering unit 620, and a reward providing unit 630 as shown in FIG. 6.

The product information receiving unit 610 may receive information about a product that is provided to a personal page subscribed to a portal site through the personal page managing service. For example, the personal page may correspond to at least one of a blog, a cafë, and a homepage. The personal page managing service may include a service that manages at least one of the blog, the cafë, and the homepage. The personal page may be assigned to the subscribed user, and a user who intends to sell a product belonging to the subscribed user may register the product by providing information about the product on the personal page.

The product registering unit 620 may register a product based on the received information about the product. The registered product may be displayed to other users using services provided by the portal site.

When information about the registered product is uploaded through the social networking service and the product is purchased via the uploaded information, the reward providing unit 630 may provide the predetermined reward to the user who uploaded the information. The user who uploaded the information may include at least one of a user subscribing to a portal site as a member and a user subscribing to a payment service as a member. The reward providing unit 630 may also provide the predetermined reward to the user who uploaded the information about the registered product through the social networking service for a first time.

When a product is purchased as a result of being displayed through at least one of the personal page, the shopping information providing service, the social networking service, and the web document searching service, the system for providing the advertisement 600 may further include a payment processing unit (not shown) that processes a payment for the product using the payment service.

For example, the system for providing the advertisement 600 may provide an integrated E-marketplace that processes an overall process of registering, displaying, and selling of a product using various services provided by the portal site, and allow existing members to work as an affiliate without an additional subscription by further including an affiliate platform for affiliate marketing.

A sale of may be conducted on a personal page on which information about a product is registered for a first time. For example, when a product is displayed on another site, information displayed may include a link to a personal page. When the product is purchased, the personal page may be provided automatically to a user requesting the purchase of the product. The purchase may be conducted on the personal page, and the payment processing unit (not shown) may process the payment for the product using the payment service. The payment service may include the check-out payment service as described above.

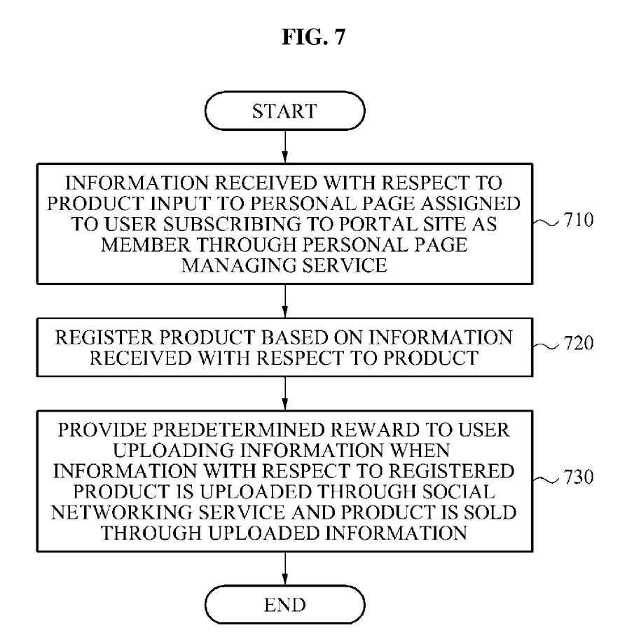

FIG. 7 is a flowchart illustrating a method for providing an advertisement. The method for providing the advertisement may be conducted by the system for providing the advertisement 600 described in FIG. 6.

In operation 710, the system for providing the advertisement 600 may receive information about a product that is provided to a personal page of a subscribed user. For example, the personal page may be at least one of a blog, a cafë, and a homepage, and a personal page managing service may include a service that manages at least one of the blog, the cafë, and the homepage. The personal page may be of the user subscribed to the portal site, and a user who intends to sell a product belonging to the user through the personal page may register the product by providing information about the product on the personal page.

In operation 720, the system for providing the advertisement 600 may register a product based on the received information about the product. The registered product may be displayed to other users using services provided by a portal site.

In operation 730, when the information about the registered product is uploaded through a social networking service and the product is purchased through the uploaded information, the system for providing the advertisement 600 may provide a predetermined reward to a user who uploaded the information. The user who uploaded the information may include at least one of a subscribed user and a subscribed user of a payment service. The system for providing the advertisement 600 may also provide the predetermined reward to a user who uploaded the information about the registered product for a first time.

When the information about the registered product is sold by being displayed through at least one of the personal page, a shopping information providing service, the social networking service, and a web document searching service, the system for providing the advertisement 600 may further conduct processing of a payment for selling of the product using the payment service. The processing of the payment may be further included in the method for providing the advertisement.

The system for providing the advertisement 600 may provide an integrated E-marketplace that processes an overall process of registering, displaying, and selling of the product using the services provided by the portal site. The system for providing the advertisement 600 may also allow existing users to work as an affiliate without an additional subscription, by further including an affiliate platform for affiliate marketing.

Sale of a product may be conducted on a personal page on which information about the product is registered (e.g. a first time product registration). For example, when the product is displayed through another site, displayed information may include a link to the personal page. When a purchase of the product is requested, the personal page may be provided to the user requesting the purchase of the product automatically. In some cases, purchasing of the product may be conducted on the personal page, and the system for providing the advertisement 600 may process the payment for selling of the product using the payment service. The payment service may include the check-out payment service as described above.

For any descriptions that may have been omitted in FIG. 6 and FIG. 7, reference may be made to FIG. 2, FIG. 3, FIG. 4 and FIG. 5.

An integrated E-marketplace may be provided by processing at least one of a registration, a display, a sale, and a payment of a product. The registration, the display, the sale, and the payment of the product may be processed by utilizing services provided by a portal site operating system. Advertising may be enhanced by providing the integrated E-marketplace that processes at least one of the registration, the display, the sale, and the payment of the product, and by providing a predetermined reward to a member working as an affiliate through an affiliate platform for affiliate marketing.

It may be possible to provide an integrated E-marketplace by processing at least one of a registration, a display, a sale, and a payment of a product.

Through the services provided by portal site operating system, it may be possible to process at least one of the registration, the display, the sale, and the payment of a product.

The advertising effect by providing a predetermined reward to a user working as an affiliate through an affiliate platform for affiliate marketing may be increased in addition to providing an integrated E-marketplace by processing at least one of a registration, a display, and a payment of a product.

The exemplary embodiments according to the present invention may be recorded in computer-readable media including program instructions to implement various operations embodied by a computer and utilizing a processor in the computer-readable media. The media may also include, alone or in combination with the program instructions, data files, and/or data structures. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM discs and DVD; magneto-optical media such as floptical discs; and hardware devices that are specially configured to store and perform program instructions, such as read-only memory (ROM), random access memory (RAM), flash memory, processor and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A system for providing an advertisement on a portal site operating system, the system comprising:
a processor;
a product information receiver to receive information, about a product provided to a personal page through a personal page managing service;
a product register to register the product based on the information; and
a reward provider unit to provide a reward for uploading the information in response to the information uploaded through a social networking service and the product being purchased via the uploaded information.

2. The system of claim 1, further comprising:
a payment processor to process a payment using a payment service in response to the product being purchased while the information is displayed through at least one of a personal page, a shopping information providing service, a social networking service, and a web document searching service.

3. The system of claim 1, wherein at least one of a user subscribing to a portal site associated with the portal site operation system and a user subscribing to a payment service uploads the information.

4. The system of claim 1, wherein the reward provider unit is configured to provide the reward to a user if the information is uploaded by the user through the social networking service for a first time.

5. The system of claim 1, wherein the product is purchased on the personal page.

6. A method of providing an advertisement in a portal site operating system, the method comprising:
receiving information about a product provided to a personal page through a personal page managing service;
registering, in a storage unit, the product based on the information; and
providing a reward for uploading the information in response to the information being uploaded through a social networking service and the product being purchased via the uploaded information.

7. The method of claim 6, further comprising:
processing a payment using a payment service in response to the product being purchased while the information is displayed through at least one of a shopping information providing service, a social networking service, and a web document searching service.

8. The method of claim 6, wherein the information is uploaded by at least one of a user subscribing to a portal site associated with the portal site operating system and a user subscribing to a payment service.

9. The method of claim 6, wherein providing the reward comprises:
providing the reward to a user if the information is uploaded by the user through the social networking service for a first time.

10. The method of claim 6, wherein the product is purchased on the personal page.

11. A non-transitory computer-readable recording medium storing a program, that when executed by a processor, implements a method, comprising:
receiving information about a product provided to a personal page through a personal page managing service;
registering, in a storage unit, the product based on the information; and
providing a reward for uploading the information in response to the information being uploaded through a social networking service and the product being purchased via the uploaded information.

12. The system of claim 11, wherein the receiving of information, the registering of the product, and providing rewards is integrated.
